(19) United States
(12) Patent Application Publication
(10) Pub. No.: US 2011/0293144 A1
(43) Pub. Date: Dec. 1, 2011

(54) Method and System for Rendering an Entertainment Animation

(75) Inventors: Susanto Rahardja, Singapore (SG); Farzam Farbiz, Singapore (SG); Zhiyong Huang, Singapore (SG); Ee Ping Ong, Singapore (SG); Corey Mason Manders, Singapore (SG); Ti Eu Chan, Singapore (SG); Bryan Jyh Herng Chong, Singapore (SG)

(73) Assignee: AGENCY FOR SCIENCE, TECHNOLOGY AND RESEARCH, Singapore (SG)

(21) Appl. No.: 13/147,591

(22) PCT Filed: Aug. 20, 2009
(86) PCT No.: PCT/SG2009/000287

§ 371 Date: Aug. 2, 2011

(30) Foreign Application Priority Data
Feb. 2, 2009 (SG) 200900695-8

(51) Int. Cl. H04N 13/02; G06T 13/00

(52) U.S. Cl. 382/103; 345/473

(57) ABSTRACT

Systems and methods for rendering an entertainment animation. The system can comprise a user input unit for receiving a non-binary user input signal; an auxiliary signal source for generating an auxiliary signal; a classification unit for classifying the non-binary user input signal with reference to the auxiliary signal; and a rendering unit for rendering the entertainment animation based on classification results from the classification unit.

### FIELD OF INVENTION

The present invention relates broadly to a method and system for rendering an entertainment animation.

### BACKGROUND

When playing an entertainment game such as an electronic dance game, a user typically directs an animated character with a binary input device, such as a floor mat, keyboard, a joystick or a mouse. The user activates keys, buttons or other controls included in order to provide binary input to a system. An example of a popular music video game in the gaming industry is Dance Dance Revolution. This game is played with a dance floor pad with four arrow panels: left, right, up, and down. These panels are pressed using the user's feet, in response to arrows that appear on the screen in front of the user. The arrows are synchronized to the general rhythm or beat of a chosen song, and success is dependent on the user's ability to time and position his or her steps accordingly.

However, current technologies do not allow a user to immerse into the entertainment game such as a virtual dancing experience since existing entertainment machines generally lack an immersive interactivity with the virtual experience that is being attempted.

A need therefore exists to provide methods and system for rendering an entertainment animation that seek to address at least one of the above-mentioned problems.

### SUMMARY

In accordance with a first aspect of the present invention there is provided a system for rendering an entertainment animation, the system comprising a user input unit for receiving a non-binary user input signal; an auxiliary signal source for generating an auxiliary signal; a classification unit for classifying the non-binary user input signal with reference to the auxiliary signal; and a rendering unit for rendering the entertainment animation based on classification results from the classification unit.

The auxiliary signal source may comprise a sound source for rendering a dance game entertainment animation.

The user input may comprise a tracking signal for tracking a user's head, hands, and body.

The classification unit may classify the tracking signal based on a kinetic energy of the tracking signal, an entropy of the tracking signal, or both.

The system may further comprise a stereo camera for capturing stereo images of the user and a tracking unit for generating the tracking signal based on image processing of the stereo images.

The user input may comprise a voice signal.

The classification unit may classify the voice signal based on a word search and identifies a response based on the word search and a dialogue database.

The system may further comprise a voice output unit for rendering the response.

The system may further comprise an evaluation unit for evaluating a match between the non-binary user input signal and the auxiliary signal for advancing the user in a game content associated with the entertainment animation.

In accordance with a second aspect of the present invention there is provided a system for rendering an entertainment animation, the system comprising a user input unit for receiving a non-binary user input signal; a classification unit for classifying the non-binary user input signal based on a kinetic energy of the non-binary user input signal, an entropy of the non-binary user input signal, or both; and a rendering unit for rendering the entertainment animation based on classification results from the classification unit.

The system may further comprise an auxiliary signal source for rendering an auxiliary signal for the entertainment animation.

The auxiliary signal may comprise a sound signal for rendering a dance game entertainment animation.

The system may further comprise an evaluation unit for evaluating a match between the non-binary user input signal and the auxiliary signal for advancing the user in a game content associated with the entertainment animation.

The user input may comprise a tracking signal for tracking a user's head, hands, and body.

The system may further comprise a stereo camera for capturing stereo images of the user and a tracking unit for generating the tracking signal based on image processing of the stereo images.

The system may further comprise a voice signal input unit.

The classification unit may classify the voice signal based on a word search and identifies a response based on the word search and a dialogue database.

The system may further comprise a voice output unit for rendering the response.

The system may further comprise an evaluation unit for evaluating a match between the non-binary user input signal and the auxiliary signal for advancing the user in a game content associated with the entertainment animation.

In accordance with a third aspect of the present invention there is provided a method of rendering an entertainment animation, the system comprising receiving a non-binary user input signal; generating an auxiliary signal; classifying the non-binary user input signal with reference to the auxiliary signal; and rendering the entertainment animation based on classification results from the classifying of the non-binary user input signal.

In accordance with a fourth aspect of the present invention there is provided a method of rendering an entertainment animation, the system comprising receiving a non-binary user input signal; classifying the non-binary user input signal based on a kinetic energy of the non-binary user input signal, an entropy of the non-binary user input signal, or both; and rendering the entertainment animation based on classification results from the classifying of the non-binary user input.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a block diagram illustrating a system for rendering an entertainment animation according to an example embodiment.

FIG. 2 shows a flowchart for speech conversation provided by the system of FIG. 1.

FIG. 3 is a schematic diagram illustrating a dance motion database of the system of FIG. 1.

FIG. 4 is a block diagram illustrating a process flow and components for analyzing and processing music for synchronizing an animated dance motion to the music in the system of FIG. 1.

FIG. 5 shows a probability gait graph for each phase in the motion database of FIG. 3.

FIG. 6 shows a schematic diagram illustrating a computer system for implementing one or more of the modules of the system of FIG. 1.

FIG. 7 is a flowchart illustrating a method of rendering an entertainment animation according to an example embodiment.

FIG. 8 shows a flowchart illustrating another method of rendering an entertainment animation according to an example embodiment.

FIG. 9 shows a diagram illustrating calculation of the time difference between the local minimum of the kinetic energy and the closest music beat for measuring how synchronous a user's movement is in respect to the input music, according to an example embodiment.

### DETAILED DESCRIPTION

The described example embodiments provide methods and systems for rendering an entertainment animation such as an immersive dance game with a virtual entity using a motion capturing and speech analysis system.

The described example embodiments can enable a user to enjoy an immersive experience by dancing with a virtual entity as well as to hold conversations in a natural manner through body movement and speech. The user can see the virtual entity using different display devices such as a head mounted display, a 3D projection display, or a normal LCD screen. The example embodiments can advantageously provide a natural interaction between the user and the virtual dancer through body movements and speech.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “inputting”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

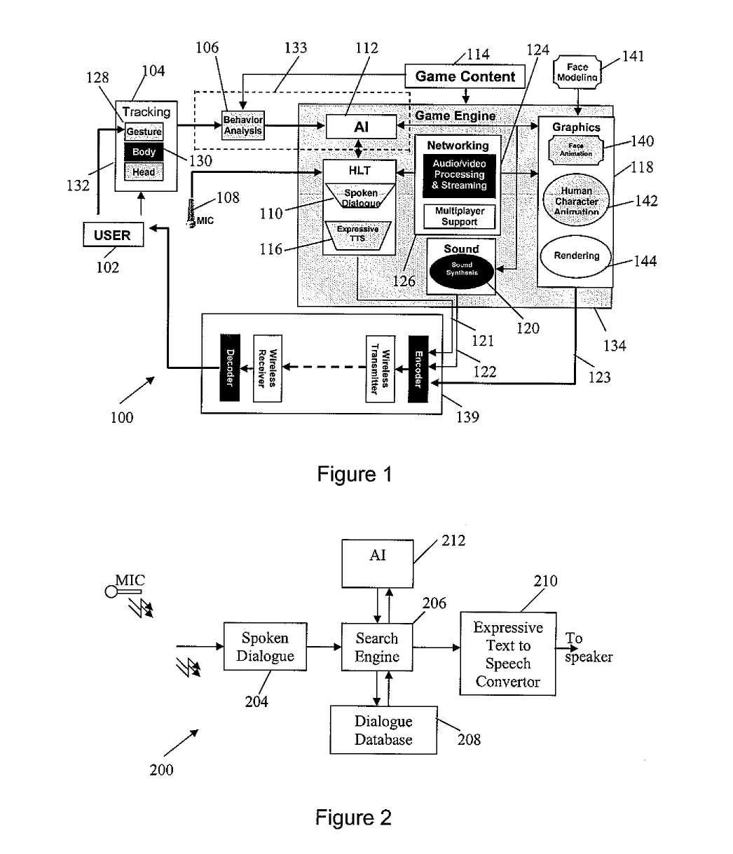

FIG. 1 shows a block diagram of a system 100 for rendering an entertainment animation in an example embodiment. The system 100 tracks a user's 102 head, hands, and body movement using a vision based tracking unit 104. A behaviour analysis unit 106 coupled to the tracking unit 104 analyzes the non-binary tracking results to recognize the user's 102 intention/behaviour from his or her movement.

In addition to the user's 102 motion, the system 100 also receives the user's 102 voice via a microphone 108 and recognizes his or her speech using a spoken dialogue module 110. The output of the behaviour analysis unit 106 and the spoken dialogue module 110 are provided to a processing module in the form of an artificial intelligence, AI, module 112 of the system 100. The processing module 112 interoperates the user's 102 input and determines a response to the user input based on a game content module 114 which governs a current game content that is being implemented on the system 100. An audio component of the response goes through an expressive TTS (text to speech) module 116 that converts the audio component of the response from text into emotional voice while a visual component of the response is handled by a graphic module 118 which is responsible for translating the visual component of the response into 3D graphics and rendering the same. The processing module 112 also sends commands to a sound analysis and synthesis module 120 that is responsible for background music. The final audio-visual outputs indicated at numeral 121, 122, 123 are transmitted wirelessly using a audio/video processing and streaming module 124 to the user 102 e.g. via a stereo head mounted display (not shown) to provide an immersive 3D audio-visual feedback to the user 102.

The system 100 also includes a networking module 126 for multiuser scenarios where users can interact with each other using virtual objects of the entertainment animation.

In the example embodiment, the tracking unit 104 comprises a gesture tracking module 128, a body tracking module 130, and a head tracking module 132. The gesture tracking module 128 implements a real time tracking algorithm that can track the user's two hands and gesture in three dimensions, advantageously regardless of the lighting and background conditions. The input of the gesture tracking module 128 are stereo camera images and the outputs are the 3D positions (X, Y, Z) of the user's hands. In an example implementation, the method described in Corey Manders, Farzam Farbiz, Chong Jyh Herng, Tang Ka Yin, Chua Gim Guan, Loke Mei Hwan “Robust hand tracking using a skin-tone and depth joint probability model”, IEEE Intl Conf Automatic Face and Gesture Recognition, (Amsterdam, Netherlands), September 2008, the contents of which are hereby incorporated by cross-reference, can be used for tracking the user's both hands in three dimensions:

The head tracking module 130 tracks the user's head in 6 degrees of freedom (position and orientation: X, Y, Z, roll, yaw, tilt), and detects the user's viewing angle for updating the 3D graphics shown on e.g. the user's head mounted display accordingly. Hence, the user 102 can see a different part of the virtual environment by simply rotating his or her head. The input of the head tracking module 130 are the stereo camera images and the outputs are the 3D positions (X, Y, Z) and 3D orientations (roll, yaw, tilt) of the user's head. In an example implementation, the method for tracking the head position and orientation using computer vision techniques as described in Louis-Philippe Morency, Jacob Whitehill, Javier Movellan “Generalized Adaptive View-based Appearance Model: Integrated Framework for Monocular Head Pose Estimation” IEEE Intl Conf Automatic Face and Gesture Recognition, (Amsterdam, Netherlands), September 2008, the contents of which are hereby incorporated by cross-reference, can be used.

The body tracking module 132 tracks the user's body. The body tracking advantageously module 132 tracks the user's body in real time. The input of the tracking module 132 are the stereo camera images and the outputs are the 3D positions of the user's body joints (e.g. torso, feet). In an example implementation, the computer vision approach for human body tracking described in Yaser Ajmal Sheikh, Ankur Datta, Takeo Kanade “On the Sustained Tracking of Human Motion” IEEE Intl Conf Automatic Face and Gesture Recognition, (Amsterdam, Netherlands), September 2008, the contents of which are hereby incorporated by cross-reference, can be used.

The behaviour analysis unit 106 analyses and interprets the results from the tracking unit 104 to determine the user's intention from moving his head, hand, and body and sends the output to the processing module 112 of the game engine 134. The behaviour analysis unit 106 together with the processing module 112 function as a classification unit 133 for classifying the non-binary tracking results. The behaviour analysis module 106 also measures the kinetic energy of the user's movement based on the 3D positions of the user's hand, the 3D positions and 3D orientations of the user's head, and the 3D positions of the user's body joints as received from the gesture tracking module 128, the head tracking module 130 and the body tracking module 132 respectively

For measuring the kinetic energy, one solution in an example implementation is to monitor the centre points of the user's tracking data on head, torso, right hand upper arm, right hand forearm, left hand upper arm, left hand forearm, right thigh, right leg, left thigh, and left leg at each frame in three dimensions and calculate the velocity, \vec{V}ᵢ(n), of each limb based on the below equation:

\vec{V}ᵢ(n)=Pᵢ(n)−Pᵢ(n−1)

where Pᵢ(n) is the 3D location of the limb centre i at frame n.

The total kinetic energy E at frame n will be:

$$E ( n ) = {\sum }_{i = 1}^{10} {m}_{i} {‖ {\vec{V}}_{i} ‖}^{2}$$

In this example implementation, mᵢ is the weighting factor considered for each limb and it is not the physical mass of the limb. For instance, more score is preferably given to the user when he moves his torso compared to the time when he only moves his head. Therefore, mₜₒᵣₛₒ>m_{head} in an example implementation.

A example way to estimate the kinetic energy in two dimensions is by calculating the motion history between consecutive frames. This can be achieved through differencing between the current frame and the previous frame and thresholding the result. For each pixel (i,j), the motion history image can be calculated from the below formula

$${I}_{motion \text{-} history} ( i , j ) = \{ \begin{matrix}1 & if \vert {I}_{n} ( i , j ) - {I}_{n - 1} ( i , j ) \vert > Tr \\ 0 & otherwise\end{matrix}$$

The number of pixels highlighted in the motion history image based on the above equation can be considered as an approximation of kinetic energy in two dimensions. To normalize the result of the above approximated method in an example implementation, the background image can be subtracted from the current image to detect the user's silhouette image first and count the foreground pixels. The normalized kinetic energy will then be:

$$E ( n ) = \frac{Number of highlighted pixels in {I}_{motion \text{-} history}}{Number of highlighted pixels in foreground image}$$

The artificial intelligence, AI, module 112 has six main functions in the example embodiment:
1—To provide speech conversation between the user 102 and the virtual character displayed e.g. via a head mounted display.
2—To synchronize the dance movement of the virtual character with the music.
3—To get the motion tracking data from the behaviour analysis unit 106 and change the virtual character dance movement based on the tracking data.
4—To measure the entropy of the user's movement
5. To measure how synchronous the user's movement is in compare to the input music
6. To score the use based on the kinetic energy, entropy, and dT value measured above.

‘Beat Detection Library’ is an example of a software application that can be used to implement the beat analysis of the music. It is available at the following link: http://adionsoft.net/bpm/, the contents of which are hereby incorporated by cross-reference. This software can be used to measure the beats and bars of the input music.

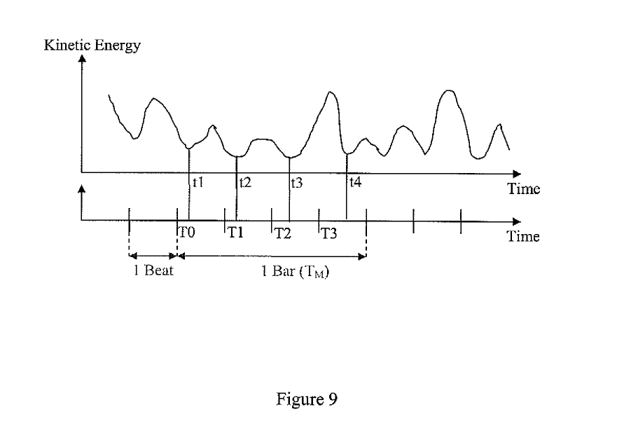

At each music bar T_{M}, as shown in FIG. 9, the time difference between the local minimum of the kinetic energy and the closest music beat is calculated and then the below formula is used to measure how synchronous the user's movement is in respect to the input music:

$$Sync = \frac{1}{1 + {\sum }_{i = 1}^{4} \vert {T}_{i - 1} - {t}_{i} \vert}$$

The above described kinetic energy measurement indicates how much the user moves at each time instance while an entropy factor specifies how non-periodic/non-repeatable the user's movement is in a specific time period. For example, if the user only jumps up and down the kinetic energy will be high while the entropy measurement will show a low value. The kinetic energy and entropy values together with time-sync measurement between the user's movement and the music are used score the user during the dance game.

To calculate the entropy in an example implementation, Shannon's entropy formula can be used, as defined by:

$$Entropy = - {\sum }_{i = 1}^{{N}_{T}} E ( i ) \cdot log ( E ( i ) )$$

where N_{T} is the number of image frames at each music bar T_{M} (bar is normally equal to 4 beats and is typically around 2-3 seconds in an example implementation) and EN is the kinetic energy at frame i.

As the above formula is not normalized, the below equation is used in an example implementation to measure the normalized version of entropy:

$$Entropy = \vert \frac{{\sum }_{i = 1}^{{N}_{T}} E ( i ) \cdot log ( E ( i ) )}{{\sum }_{i = 1}^{{N}_{T}} E ( i )} \vert$$

The user is preferably scored based on kinetic energy, entropy, and synchronization with input music at each music bar T_{M}. An example score calculation can be as provided below.

$$Score = α \cdot \frac{1}{{N}_{T}} {\sum }_{i = 1}^{{N}_{T}} E ( i ) + β \cdot Entropy + γ \cdot Sync$$

where α, β, and γ are the scaling factors.

The audio/video processing and streaming module 124 encodes and decodes stereo video and audio data in order to send 3D information to the user 102 or to multiple users.

FIG. 2 shows a flowchart 200 for the speech conversation function provided by the processing module 112 (FIG. 1). The user's speech is recorded by a closed-talk microphone 202 attached to the user 102 (FIG. 1). The speech signal is wirelessly transmitted to the spoken dialogue sub-module 204 which converts voice signal to text data. A search engine sub-module 206 analyzes the content of the text data and based on specific keywords and information from the processing module 112 (FIG. 1) regarding the status of the game (e.g. dancing level) searches a dialogue data base 208 to provide a response to the user's 102 (FIG. 1) voice signal. The output of the search is a text data together with emotion indicators. This information is then sent to the expressive-text-to-speech sub-module 210 to convert the text into expressive speech. The output speech signal is either played together with the music through the speaker or it is sent wirelessly to an earphone worn by the user 102 (FIG. 1).

Expressive text-to-speech synthesis (TTS) module 210 may be achieved using Loquendo text-to-speech (TTS) synthesis (http://www.loquendo.com/en/technology/TTS.htm) or IBM expressive TTS (Pitrelli, J. F. Bakis, R. Eide, E. M. Fernandez, R. Hamza, W. Picheny, M. A., “The IBM expressive text-to-speech synthesis system for American English”, IEEE Transactions on Audio, Speech and Language Processing, July 2006, Volume: 14, Issue: 4, pp. 1099-1108), the contents of both of which are hereby incorporated by cross-reference. The spoken dialogue module 204 and the related search engine 206 may be achieved as described in Yeow Kee Tan, Dilip Limbu Kumar, Ridong Jiang, Liyuan Li, Kah Eng Hoe, Xinguo Yu, Li Dong, Chern Yuen Wong, and Haizhou Li, “An Interactive Robot Butler”, book chapter in Human-Computer Interaction. Novel Interaction Methods and Techniques, Lecture Notes in Computer Science, Volume 5611, 2009, the contents of which are hereby incorporated by cross-reference.

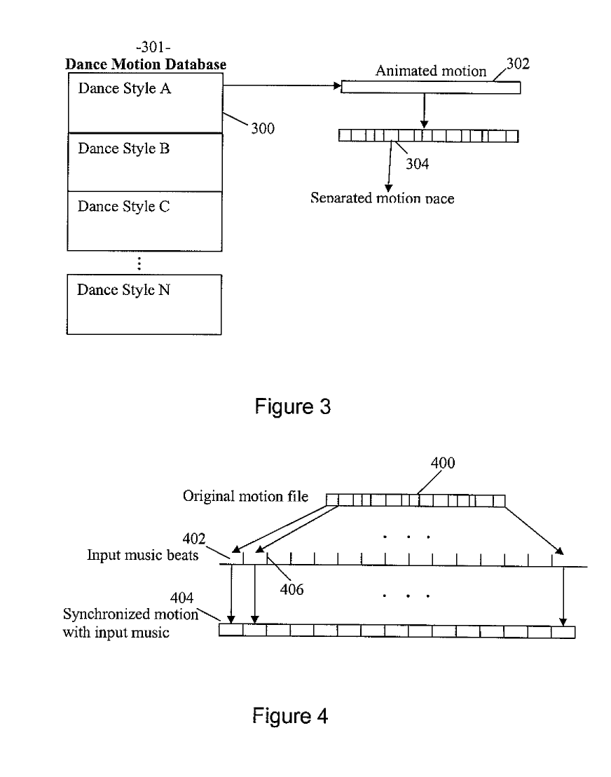

In the example embodiment, an animated motion database is created for the system 100 (FIG. 1) to hold different dance styles. As is shown in FIG. 3, each dance style e.g. 300 includes several animated dance motion sequence files e.g. 302. These motion files are further split into smaller pieces e.g. 304 so that each piece contains a separate pace of the dance motion. The original motion file 302 can be constructed by putting all its paces together with their original timing info.

With reference to FIG. 4, when a motion file 400 is selected to play, the system 100 (FIG. 1) will analyze the music first and extract the music beats 402. Then the frame rate of animated paces e.g. 404 at each moment will be modified in such a way that each motion pace e.g. 404 is completed at each music beat e.g. 406. Hence, the animated dance motion of the virtual character and the input music are advantageously synchronized together.

If there is no user selection of the dance style/dance motion file, the system randomly picks one of the animated dance motion files from the dance motion database 301 (FIG. 3) based on the style of the input music, synchronizes the paces, and then renders the virtual character with the synchronized animated motion. The system 100 (FIG. 1) tracks the users body movement and can change the animated paces from one motion file to the pace of another file (or another pace in the same file) which contains more similar motion content to the user's movement and preferably also matched to the current pace.

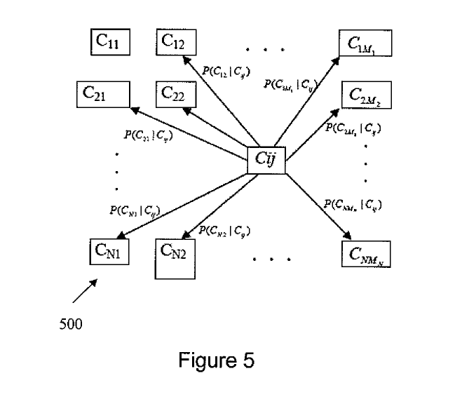

A probability gait graph 500 for each pace Cᵢⱼ in the motion database 301 (FIG. 3) is built, as illustrated in FIG. 5. The probability gait graph 500 shows the transition probability for moving from that pace to all other paces in the dance motion database 301 (FIG. 3). The user's motion input will change these probabilities and can trigger the virtual dance animation to move from one pace to another.

Returning to FIG. 1, LAN-based multi-user interaction module 138 is included in the game engine 134. It will be appreciated that a multiuser online version can alternatively or additionally be implemented in different embodiments. Game content governed by the game content module 114 is typically generated by a game artist and level layout designers and are specific to a target game and such-like application. The game content can include 3D visualization data, sound effects, background music, static/dynamic animation data, static/animated textures and other data that are used to construct a game.

The spoken dialogue module 110 receives the user's 102 voice through the microphone 108, converts it into text, and sends the text output to processing module 112.

The expression TTS module 116 receives text data and emotion notes from the processing module 112 and converts it into voice signal. The output voice signal is sent to the user's stereo earphone wirelessly using the audio/video processing and streaming module 139.

The face animation module 140 provides facial expression for the virtual dancer based on the emotion notes received from the processing module 112 and based on a modelled face from a face modelling module 141. Face modelling module 141 can be implemented using a software application such as Autodesk Maya (http://usa.autodesk.com) or FaceGen Modeller (http://www.facegen.com), the contents of both of which are hereby incorporated by cross-reference. Face animation module 140 can be implemented using algorithms such as those described in Yong CAO, Wen C. Tien, Fredric Pighin, “Expressive Speech-driven facial animation”, ACM Transactions on Graphics (TOG), Volume 24, Issue 4 (October 2005), Pages: 1283-1302, 2005; or in Zhigang Deng, Ulrich Neumann, J. P. Lewis, T. Y. Kim, M. Bulut, and S. Narayanan, “Expressive facial animation synthesis by learning speech co-articulation and expression spaces” IEEE Trans. Visualization and computer graphics, vol 12, no. 6 November/December 2006, the contents of both of which are hereby incorporated by cross-reference.

The human character animation module 142 moves the body and joints of the virtual dancer according to the music and also in response to the user's body movements. The input of the module 142 comes from the processing module 112 (i.e. the current pace) and the outputs of the module 142 are 3D information of the virtual character joints. In an example implementation, Havok Engine (http://www.havok.com), the contents of which are hereby incorporated by cross-reference, can be used for character animation in the human character animation module 142.

The rendering module 144 renders the 3D object(s) on the display device, e.g. on the user's head mounted display via the wireless transmitter module 139. The input of the module 144 comes from the output of the human character animation module 142 and the output of the module is the 2D/3D data displayed on either user's head mounted display or a 3D projection screen. As an alternative to the Havok Engine mentioned above, which also includes a rendering capability, another commercial off-the-shelf software that can be used is e.g. SGI's OpengGL Performer (http://www.opengl.org), the contents of which are hereby incorporated by cross-reference, which is a powerful and comprehensive programming interface for developers creating real-time visual simulation and other professional performance-oriented 3D graphics applications that can be applied to rendering module 144. It provides functions of rendering 3D animation and visual effects.

The sound analysis and synthesis module 120 generates sound effects and changes the music according to the user's input and the game content. The module 120 also calculates the beats of the input music and passes the beat info to the processing module 112. A sound card is an example of the hardware that can be used to implement the sound analysis and synthesis module 120 to generate the music and sound effects. ‘Beat Detection Library’ (http://adionsoft.net/bpm/), the contents of which are hereby incorporated by cross-reference, is an example of a software application that can be used to implement the beat analysis of the music.

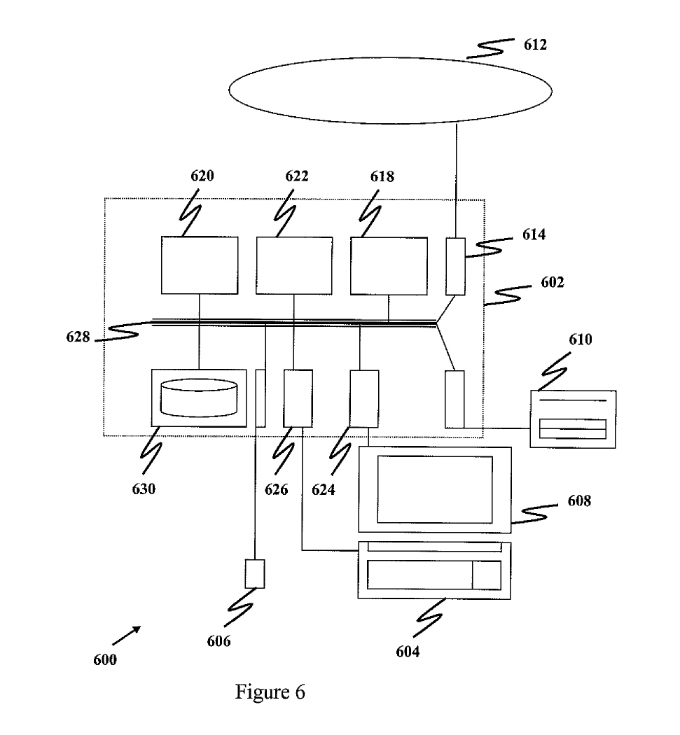

The modules of the system 100 of the example embodiment can be implemented on one or more computer systems 600, schematically shown in FIG. 6. It may be implemented as software, such as a computer program being executed within the computer system 600, and instructing the computer system 600 to conduct the method of the example embodiment.

The computer system 600 comprises a computer module 602, input modules such as a keyboard 604 and mouse 606 and a plurality of output devices such as a display 608, and printer 610.

The computer module 602 is connected to a computer network 612 via a suitable transceiver device 614, to enable access to e.g. the Internet or other network systems such as Local Area Network (LAN) or Wide Area Network (WAN).

The computer module 602 in the example includes a processor 618, a Random Access Memory (RAM) 620 and a Read Only Memory (ROM) 622. The computer module 602 also includes a number of Input/Output (I/O) interfaces, for example I/O interface 624 to the display 608, and I/O interface 626 to the keyboard 604.

The components of the computer module 602 typically communicate via an interconnected bus 628 and in a manner known to the person skilled in the relevant art.

The application program is typically supplied to the user of the computer system 600 encoded on a data storage medium such as a CD-ROM or flash memory carrier and read utilizing a corresponding data storage medium drive of a data storage device 630. The application program is read and controlled in its execution by the processor 618. Intermediate storage of program data maybe accomplished using RAM 620.

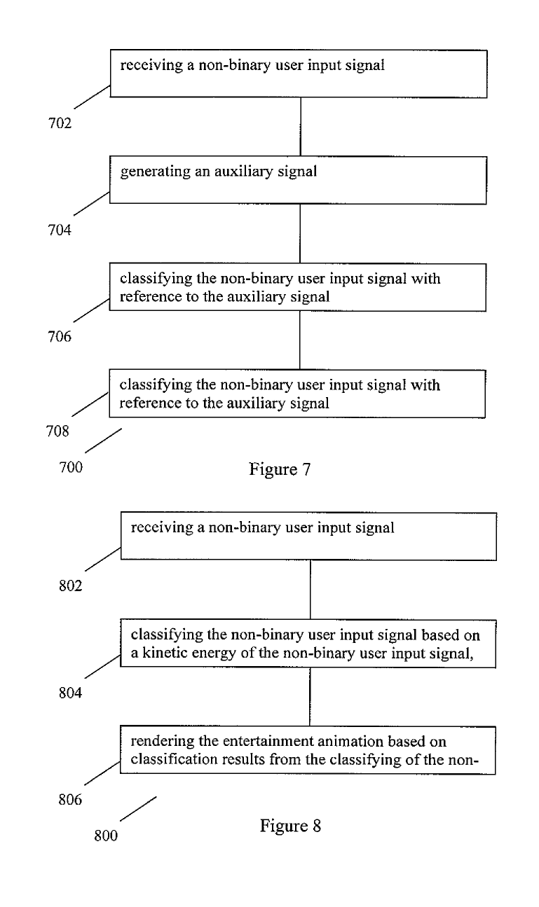

FIG. 7 shows a flowchart 700 illustrating a method for rendering an entertainment animation according to an example embodiment. At step 702, a non-binary user input signal is received. At step 704, an auxiliary signal is generated. At step 706, the non-binary user input signal is classified with reference to the auxiliary signal. At step 708, the entertainment animation is rendered based on classification results from the classifying of the non-binary user input signal.

FIG. 8 shows a flowchart 800 illustrating another method of rendering an entertainment animation according to an example embodiment. At step 802, a non-binary user input signal is received. At step 804, the non-binary user input signal is classified based on a kinetic energy of the non-binary user input signal, and entropy of the non-binary user input signal, or both. At step 806, the entertainment animation is rendered based on classification results from the classifying of the non-binary user input signal.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A system for rendering an entertainment animation, the system comprising:
a user input unit for receiving a non-binary user input signal;
an auxiliary signal source for generating an auxiliary signal;
a classification unit for classifying the non-binary user input signal with reference to the auxiliary signal; and
a rendering unit for rendering the entertainment animation based on classification re-sults from the classification unit.

2. The system as claimed in claim 1, wherein the auxiliary signal source comprises a sound source for rendering a dance game entertainment animation.

3. The system as claimed in claim 1, wherein the user input comprises a tracking signal for tracking a user's head, hands, and body.

4. The system as claimed in claim 3, wherein the classification unit classifies the tracking signal based on a kinetic energy of the tracking signal, an entropy of the tracking signal, or both.

5. The system as claimed in claim 3, further comprising a stereo camera for capturing stereo images of the user and a tracking unit for generating the tracking signal based on image processing of the stereo images.

6. The system as claimed in claim 1, wherein the user input comprises a voice signal.

7. The system as claimed in claim 6, wherein the classification unit classifies the voice signal based on a word search and identifies a response based on the word search and a dialogue database.

8. The system as claimed in claim 7, further comprising a voice output unit for rendering the response.

9. The system as claimed in claim 1, further comprising an evaluation unit for evaluating a match between the non-binary user input signal and the auxiliary signal for advancing the user in a game content associated with the entertainment animation.

10. A system for rendering an entertainment animation, the system comprising:
a user input unit for receiving a non-binary user input signal;
a classification unit for classifying the non-binary user input signal based on a kinetic energy of the non-binary user input signal, an entropy of the non-binary user input signal, or both; and
a rendering unit for rendering the entertainment animation based on classification re-sults from the classification unit.

11. The system as claimed in claim 10, further comprising an auxiliary signal source for rendering an auxiliary signal for the entertainment animation.

12. The system as claimed in claim 11, wherein the auxiliary signal comprises a sound signal for rendering a dance game entertainment animation.

13. The system as claimed in claim 10, further comprising an evaluation unit for evaluating a match between the non-binary user input signal and the auxiliary signal for advancing the user in a game content associated with the entertainment animation.

14. The system as claimed in claim 10, wherein the user input comprises a tracking signal for tracking a user's head, hands, and body.

15. The system as claimed in claim 14, further comprising a stereo cam-era for capturing stereo images of the user and a tracking unit for generating the tracking signal based on image processing of the stereo images.

16. The system as claimed in claim 10, further comprising a voice signal input unit.

17. The system as claimed in claim 16, wherein the classification unit classifies the voice signal based on a word search and identifies a response based on the word search and a dialogue database.

18. The system as claimed in claim 17, further comprising a voice out-put unit for rendering the response.

19. The system as claimed in claim 18, further comprising an evaluation unit for evaluating a match between the non-binary user input signal and the auxiliary signal for advancing the user in a game content associated with the entertainment animation.

20. A method of rendering an entertainment animation, the method comprising:
receiving a non-binary user input signal;
generating an auxiliary signal;
classifying the non-binary user input signal with reference to the auxiliary signal; and
rendering the entertainment animation based on classification results from the classifying of the non-binary user input signal.

21. A method of rendering an entertainment animation, the method comprising:
receiving a non-binary user input signal;
classifying the non-binary user input signal based on a kinetic energy of the non-binary user input signal, an entropy of the non-binary user input signal, or both; and
rendering the entertainment animation based on classification results from the classifying of the non-binary user input.
